(19) United States
(12) Patent Application Publication
(10) Pub. No.: US 2010/0297935 A1
(43) Pub. Date: Nov. 25, 2010

(54) APPARATUS AND METHOD FOR SYNCHRONIZING FREQUENCY IN DISTRIBUTED REPEATER

(76) Inventors: Ho-Min Eum, Daejon (KR); Yong-Tae Lee, Daejon (KR); Heung-Mook Kim, Daejon (KR); Jae-Hyun Seo, Daejon (KR); Sung-Ik Park, Daejon (KR); Jae-Young Lee, Seoul (KR); Jong-Soo Lim, Daejon (KR); Soo-In Lee, Daejon (KR)

Correspondence Address: LADAS & PARRY LLP, 224 SOUTH MICHIGAN AVENUE, SUITE 1600, CHICAGO, IL, 60604, US

(21) Appl. No.: 12/517,969

(22) PCT Filed: Dec. 6, 2007
(86) PCT No.: PCT/KR2007/006314

§ 371 Date: Jun. 5, 2009

(30) Foreign Application Priority Data
Dec. 8, 2006 (KR) 10-2006-0124565

(51) Int. Cl. H04B 7/14

(52) U.S. Cl. 455/7

(57) ABSTRACT

Provided is a frequency synchronizing apparatus and method that can synchronize center frequency of radio frequency (RF) transmission signals among distributed repeaters using identical signals as mother signals by reflecting sampling information acquired in a timing recovery process of reception signals transmitted from a main transmitter or other repeaters. The apparatus for synchronizing frequency in distributed repeaters includes: a timing recoverer for compensating sampling timing offset of reception signals; an intermediate frequency (IF) timing offset information reflector for applying the sampling timing offset information extracted in the timing recoverer to digital-to-analog conversion; and a radio frequency (RF) timing offset information reflector for applying the sampling timing offset information extracted in the timing recoverer to RF up-conversion as a reference signal.

### TECHNICAL FIELD

The present invention relates to an apparatus and method for synchronizing frequency of distributed repeaters; and, more particularly, to a frequency synchronizing apparatus and method that can synchronize center frequency of radio frequency (RF) transmission signals among distributed repeaters using identical signals as mother signals by reflecting sampling information acquired in a timing recovery process of reception signals transmitted from a main transmitter or other repeaters.

This work was supported by the Fr R&D program of MIC/IITA [2006-S-016-01, “Development of Distributed Translator Technology for Terrestrial DTV”].

### BACKGROUND ART

Generally, main transmitters and repeaters are disposed in service areas according to natural features and environment.

Repeaters are set up in area where signals transmitted from a main transmitter are received weak to resolve a problem of poor signal reception and extend the signal transmission coverage of the main transmitter.

FIG. 1 illustrates a service employing conventional repeaters according to a related art. According to the service, the channels of signals outputted from the repeaters are different from that of the main transmission signals, and adjacent repeaters repeat signals through different channels.

In the service using conventional repeaters, which is illustrated in FIG. 1, signals are outputted from a main transmitter 101 through a transmission frequency A, and the repeaters 102 to 105 repeat the outputted signals through different frequencies B, C, D, and E, respectively. Since the repeaters shown in FIG. 1 are given with different frequencies B, C, D and E, respectively, many frequency resources are required. This is very inefficient from the perspective of frequency utility.

FIG. 2 illustrates a service employing conventional repeaters according to another related art. According to the service, channels of signals outputted from the repeaters 202 to 205 are different from that of a main transmitter 201, but the signal channels of the repeaters 202 to 205 are the same. Herein, the signal channels signify frequency. To be specific, the main transmitter 201 outputs signals through a transmission frequency A, and the distributed repeaters 202 to 205 repeat the outputted signals through frequency B, which is different from the main transmission frequency A.

Since the repeaters, which are set up to resolve the problem of weak signal reception in an area within the coverage of the main transmitter or extend a service coverage, do not use many frequency bands and uses only one additional frequency band B, the service is efficient from the perspective of frequency utility, compared to the service using multiple frequency bands.

FIGS. 3 and 4 show examples of the distributed repeaters. FIG. 3 is a block diagram showing a conventional non-demodulative distributed repeater employing a Global Positioning System (GPS).

The non-demodulative distributed repeater employing GPS includes a reception antenna 301, an RF receiver 302, an RF filter 303, a frequency converter 304, a high power amplifier 305, a transmission antenna 306, and a GPS receiver 307.

FIG. 4 is a block diagram showing a conventional demodulative distributed repeater employing GPS.

The conventional demodulative distributed repeater employing GPS includes a reception antenna 401, an RF receiver 402, an intermediate frequency (IF) down-converter 403, a demodulator 404, an equalizer 405, a modulator 406, an RF up-converter 407, a high power amplifier 408, a transmission antenna 409, and a GPS receiver 410.

When reception signals do not go through a modulation process, which is a case of FIG. 3, distributed repeaters generally have a GPS receiver installed therein. When reception signals go through a modulation process, which is a case of FIG. 4, a GPS receiver is installed in a main transmitter and distributed repeaters and signals outputted from the GPS are used as reference frequency.

Therefore, conventional distributed repeaters have a drawback that their structure is complicated because a GPS receiver has to be set up and signals outputted from the GPS receiver should be referred to in order to use frequency.

### DISCLOSURE OF INVENTION

### Technical Problem

An embodiment of the present invention is directed to providing a frequency synchronizing apparatus and method for synchronizing RF frequency among output signals of distributed repeaters using identical signals as mother signals with no reference to any reference frequency outputted from a separate device, such as a GPS receiver, by extracting sampling timing offset information from a timing recovery process of reception signals received from a main transmitter or another distributed repeater and reflecting the sampling timing offset information to transmission signals.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided an apparatus for synchronizing frequency in distributed repeaters, which includes: a timing recoverer for compensating sampling timing offset of reception signals; an intermediate frequency (IF) timing offset information reflector for applying the sampling timing offset information extracted in the timing recoverer to digital-to-analog conversion; and a radio frequency (RF) timing offset information reflector for applying the sampling timing offset information extracted in the timing recoverer to RF up-conversion as a reference signal.

In accordance with another aspect of the present invention, there is provided a method for synchronizing frequency in distributed repeaters, which includes the steps of: recovering sampling frequency of reception signals; and reflecting recovered sampling frequency to IF transmission signals and RF transmission signals.

### ADVANTAGEOUS EFFECTS

As described above, the apparatus and method of the present invention can synchronize RF center frequency among all distributed repeaters receiving identical mother signals with no reference to reference signals transmitted from an external device, such as GPS, by extracting sampling timing offset information from reception signals transmitted from a main transmitter or another distributed repeater and using the sampling timing offset information as a reference signal for digital-to-analog conversion and RF up-conversion in the distributed repeaters.

### BRIEF DESCRIPTION OF THE DRAWINGS

FIG. 1 illustrates a service employing conventional repeaters according to a related art.

FIG. 2 illustrates a service employing conventional repeaters according to another related art.

FIG. 3 is a block diagram showing a conventional non-demodulative distributed repeater employing a Global Positioning System (GPS).

FIG. 4 is a block diagram showing a conventional demodulative distributed repeater employing GPS.

FIG. 5 is a block diagram describing a demodulative distributed repeater in accordance with an embodiment of the present invention.

FIG. 6 is a block diagram illustrating a frequency synchronizing apparatus for a distributed repeater in accordance with an embodiment of the present invention.

FIG. 7 is a block diagram describing a frequency synchronizing apparatus for a distributed repeater in accordance with another embodiment of the present invention.

FIG. 8 is a flowchart describing a frequency synchronizing method for a distributed repeater in accordance with an embodiment of the present invention.

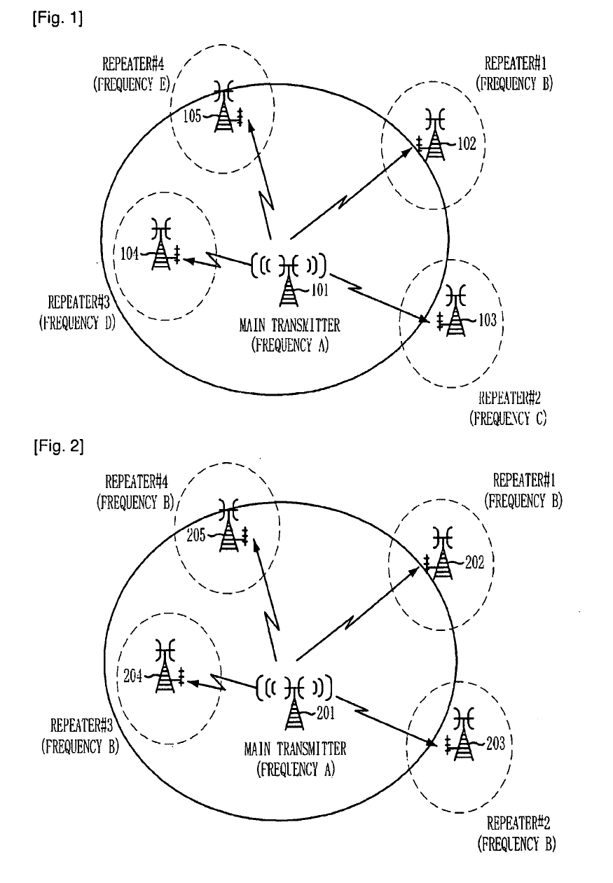

### MODE FOR THE INVENTION

The advantages, features and aspects of the invention will become apparent from the following description of the embodiments with reference to the accompanying drawings, which is set forth hereinafter. When it is considered that detailed description on a related art may obscure the points of the present invention, the description will not be provided herein. Hereinafter, specific embodiments of the present invention will be described with reference to the accompanying drawings. Herein, the same reference numerals are given to the same constituent elements, although they appear in different drawings.

A frequency synchronizing apparatus and method for a distributed repeater, which is suggested in the present invention, is proper to digital television broadcasting, such as Advanced Television System Committee (ATSC) systems and Digital Video Broadcasting (DVB) systems, but its application field is not limited to it. The apparatus and method of the present invention is applicable to any environments that require repeaters to form a general distributed repeating network.

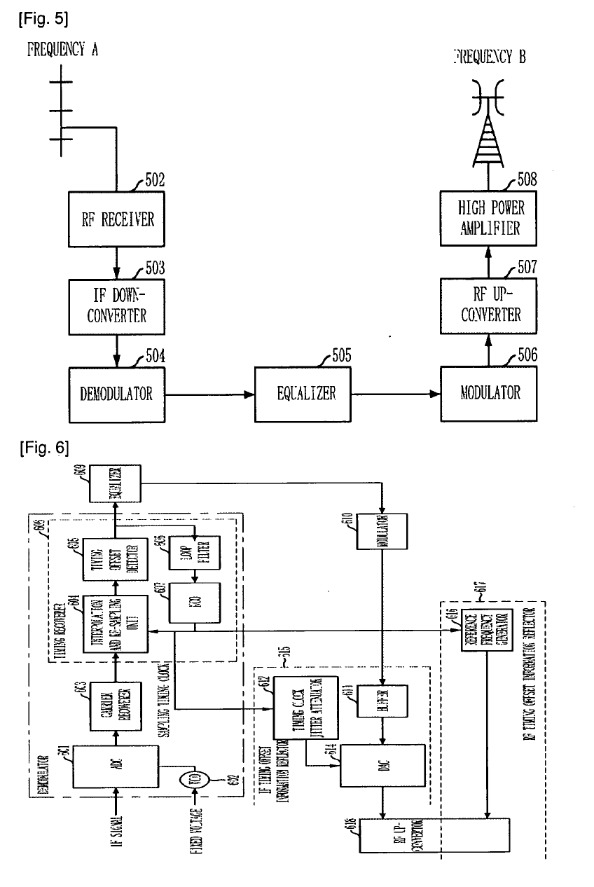

FIG. 5 is a block diagram describing a demodulative distributed repeater in accordance with an embodiment of the present invention. The demodulative distributed repeater includes a RF receiver 502, an IF down-converter 503, a demodulator 504, an equalizer 505, a modulator 506, an RF up-converter 507, and a high power amplifier 508.

The RF receiver 502 receives RF signals from a main transmitter or another distributed repeater. The TF down-converter 503 down-converts the RF signals received in the RF receiver 502 into IF signals. The demodulator 504 converts the IF signals into baseband signals. The equalizer 505 equalizes the baseband signals acquired in the demodulator 504 to compensate for distortion occurring in a transmission channel. The modulator 506 converts the baseband signals outputted form the equalizer 505 into IF signals. The RF up-converter 507 up-converts the IF signals into RF signals. The high power amplifier 508 amplifies the RF signals.

Herein, the RF transmission signals of the distributed repeater have a different channel from the RF reception signals of the distributed repeater transmitted from the main transmitter or another distributed repeater, and the center frequency of RF transmission signals among distributed repeaters is the same.

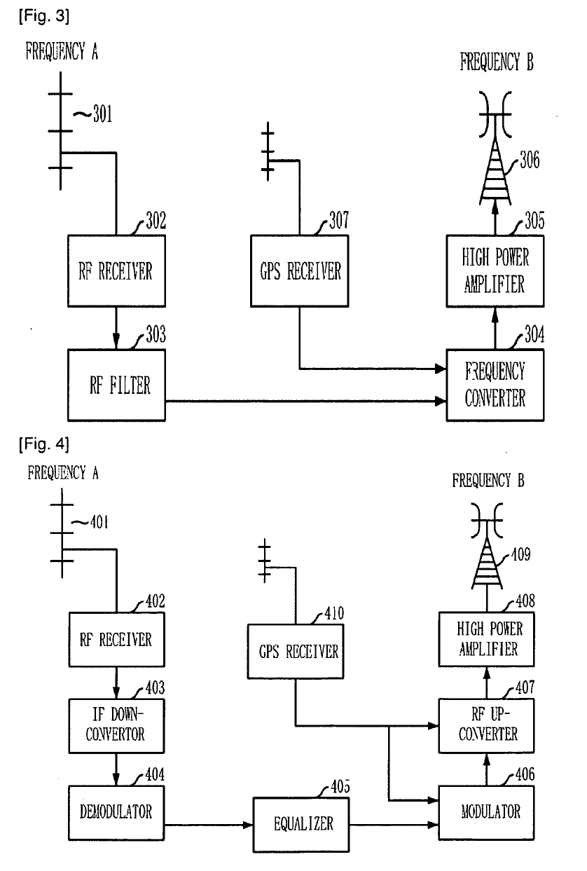

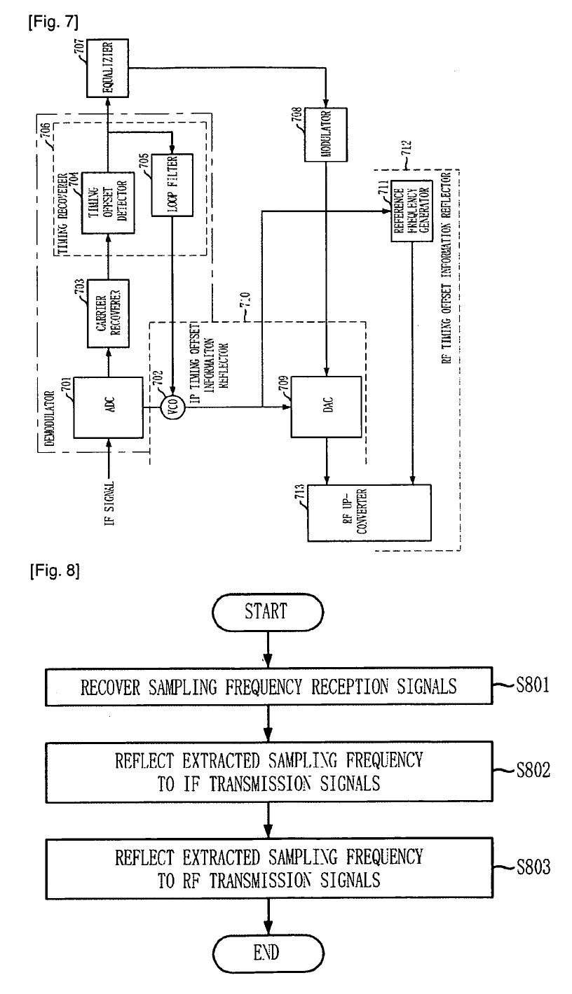

The RF center frequency is synchronized among the distributed repeaters in two methods. One is a method using reference signals transmitted from an external device, which is described in FIGS. 3 and 4, such as GPS, and the other is a method of using sampling timing offset information of reception signals. The frequency synchronizing method of the present invention does not use any reference signals transmitted from an external device, such as GPS, which is described in FIGS. 6 and 7.

Hereinafter, the method of synchronizing frequency among distributed repeaters will be described in detail. Digital signals generated in the main transmitter go through digital-to-analog conversion, up-converted into predetermined RF signals, and transmitted in the air through an antenna. When it is assumed that a theoretical symbol rate of baseband symbols before the digital-to-analog conversion is f_{sym}, the actual symbol rate is f_{sym}+Δf_{sym}. When upsampling is performed n times for a modulation process such as filtering where n is a natural number, the sample rate is (f_{sym}+Δf_{sym})*n. Timing recovery in a distributed repeater is a process of recovering symbols by generating clocks as many as m-fold (f_{sym}+Δf_{sym}) where m is a natural number. In short, (f_{sym}+Δf_{sym})*m clocks are generated. All distributed repeaters receiving the same signal generate the same (f_{sym}+Δf_{sym})*m clocks.

Since all distributed repeaters receiving the same mother signals can generate the same clocks, the clocks may be referred to as reference frequency to synchronize the center frequency of RF transmission signals among the distributed repeaters. Herein, only the timing clock frequency is the same and the timing clock phase may be different among the distributed repeaters. However, the difference in timing clock phase does not make great influence on the performance of a receiver in an area where signal reception coverages of distributed repeaters are overlapped.

The apparatus for synchronizing frequency among distributed repeaters, which is suggested in the present invention, has two types according to what is inputted to a voltage-controlled oscillator which provides oscillation frequency to analog-to-digital conversion. When fixed voltage is inputted to the voltage-controlled oscillator, the frequency synchronizing apparatus is of a digital type. When output of a timing recoverer is inputted to the voltage-controlled oscillator, the frequency synchronizing apparatus is of a digital-analog type. The frequency synchronizing apparatus of the present invention will be described in detail with reference to FIGS. 6 and 7.

FIG. 6 is a block diagram illustrating a frequency synchronizing apparatus for a distributed repeater in accordance with an embodiment of the present invention.

Referring to FIG. 6, the frequency synchronizing apparatus for distributed repeaters includes a timing recoverer 608, an IF timing offset information reflector 615, and an RF timing offset information reflector 617. The timing recoverer 608 compensates for sampling timing offset of reception signals. The IF timing offset information reflector 615 applies sampling timing offset information extracted in the timing recoverer 608 to digital-to-analog conversion. The RF timing offset information reflector 617 applies the sampling timing offset information extracted in the timing recoverer 608 to RF up-conversion as reference signals.

The timing recoverer 608 includes an interpolation and re-sampling unit 604, a timing offset detector 605, a loop filter 606, and a numerically controlled oscillator 607. The interpolation and re-sampling unit 604 performs interpolation and re-sampling using oscillation frequency transmitted from the numerically controlled oscillator 607. The timing offset detector 605 detects timing offset from signals outputted from the interpolation and re-sampling unit 604. The loop filter 606 filters the signals outputted from the timing offset detector 605. The numerically controlled oscillator 607 oscillates oscillation frequency according to a signal transmitted from the loop filter 606 and provides it to the interpolation and re-sampling unit 604, the IF timing offset information reflector 615, and the RF timing offset information reflector 617.

The IF timing offset information reflector 615 includes a buffer 611 for buffering signals transmitted from the demodulator 610, a timing clock jitter attenuator 612, e.g., Dull phase-locked loop (DPLL), and a digital-to-analog converter 614. The timing clock jitter attenuator 612 attenuates jitter of sample timing clocks from the timing recoverer 608. The digital-to-analog converter 614 converts digital signals into analog signals using sample timing clocks whose jitter is attenuated in the timing clock jitter attenuator 612.

The RF timing offset information reflector 617 includes a reference frequency generator 616 for generating reference frequency of the RF up-converter based on the sample timing clock extracted in the timing recoverer 608.

The digital frequency synchronizing apparatus for distributed repeaters, which is suggested in the present invention, receives the oscillation frequency from a voltage-controlled oscillator 602 using fixed voltage as input when signals are converted in the analog-to-digital converter 601.

In general, sampling frequency used during the analog-to-digital conversion is a frequency of (f_{sym}+Δf_{sym})*m+alpha, which is a bit higher than a multiple number of a symbol rate.

Digital signals sampled through the analog-to-digital conversion has a sample rate of (f_{sym}+Δf_{sym})*m, after going through timing recovery. The clock frequency generated after the timing recovery is the same among all distributed repeaters receiving the same mother signals. Therefore, the generated clock frequency can be used as reference frequency for subsequent digital-to-analog conversion and RF up-conversion in the distributed repeaters.

The reference frequency (f_{sym}+Δf_{sym})*m which is generated from the timing recovery is digital clock in a digital-type frequency synchronizing apparatus, whereas it is an analog oscillation signal in a digital-analog-type frequency synchronizing apparatus shown in FIG. 7.

The digital clock (f_{sym}+Δf_{sym})*m generated in FIG. 6 may be directly used in the digital-to-analog conversion, or it may be used after its jitter is attenuated in the timing clock jitter attenuator 612, e.g., DPLL.

FIG. 7 is a block diagram describing a frequency synchronizing apparatus for a distributed repeater in accordance with another embodiment of the present invention. It shows a digital-analog-type frequency synchronizing apparatus.

In case of the digital-analog-type frequency synchronizing apparatus shown in FIG. 7, an analog oscillation signal having a frequency of (f_{sym}+Δf_{sym})*m is used for the digital-to-analog conversion.

The digital-analog-type frequency synchronizing apparatus includes a timing recoverer 706, an IF timing offset information reflector 710, and an RF timing offset information reflector 712. The timing recoverer 706 compensates for sampling timing offset of reception signals. The IF timing offset information reflector 710 applies the sampling timing offset information extracted in the timing recoverer 706 to digital-to-analog conversion. The RF timing offset information reflector 712 applies the sampling timing offset information extracted in the timing recoverer 706 to RF up-conversion as a reference signal.

The timing recoverer 706 includes a timing offset detector 704 and a loop filter 705. The timing offset detector 704 detects timing offset in signals transmitted from a carrier recoverer 703. The loop filter 705 filters signals transmitted from the timing offset detector 704 and outputs filtered signals to a voltage-controlled oscillator 702.

The IF timing offset information reflector 710 includes the voltage-controlled oscillator 702 for performing oscillation according to a signal transmitted from the loop filter 705, and a digital-to-analog converter 709 for converting digital signals into analog signals.

The RF timing offset information reflector 712 includes a reference frequency generator 711 for generating reference frequency of the RF up-converter based on the sample timing clock extracted in the timing recoverer 706.

As described above, since demodulation and re-modulation are performed based on the same clocks and digital-to-analog conversion occurs based on the same reference frequency in the distributed repeaters, center frequency of IF signals are synchronized among the distributed repeaters.

When digital clocks or analog oscillation signals of (f_{sym}+Δf_{sym})*m generated in the timing recovery are used as reference frequency in the RF up-conversion, the respective distributed repeaters use the same reference frequency. Therefore, the RF center frequency is synchronized among the distributed repeaters.

FIG. 8 is a flowchart describing a frequency synchronizing method for a distributed repeater in accordance with an embodiment of the present invention.

In step S801, sampling frequency of reception signals is recovered.

In step S802, the recovered sampling clock is reflected to IF transmission signals.

In step S803, the recovered sampling clock is reflected to RF transmission signals.

As described above, the method of the present invention can be realized as a program and stored in a computer-readable recording medium, such as CD-ROM, RAM, ROM, floppy disks, hard disks, magneto-optical disks and the like. Since the process can be easily implemented by those of ordinary skill in the art to which the present invention pertains, further description will not be provided herein.

The present application contains subject matter related to Korean Patent Application No. 2006-0124565, filed in the Korean Intellectual Property Office on Dec. 8, 2006, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. An apparatus for synchronizing frequency in distributed repeaters, comprising:
a timing recoverer for compensating sampling timing offset of reception signals;
an intermediate frequency (IF) timing offset information reflector for applying the sampling timing offset information extracted in the timing recoverer to digital-to-analog conversion; and
a radio frequency (RF) timing offset information reflector for applying the sampling timing offset information extracted in the timing recoverer to RF up-conversion as a reference signal.

2. The apparatus of claim 1, wherein the timing recoverer includes:
an interpolation and re-sampling unit for performing interpolation and re-sampling onto signals outputted from a carrier recoverer;
a timing offset detector for detecting timing offset in signals outputted from the interpolation and re-sampling unit;
a filter for filtering signals outputted from the timing offset detector; and
a numerically controlled oscillator for oscillating oscillation frequency according to a signal outputted from the filter and providing the oscillation frequency to the interpolation and re-sampling unit, the IF timing offset information reflector, and the RF timing offset information reflector.

3. The apparatus of claim 1, wherein the timing recoverer includes:
a timing offset detector for detecting timing offset in signals outputted from the carrier recoverer; and
a filter for filtering signals outputted from the timing offset detector, and outputting the filtered signals to the IF timing offset information reflector.

4. The apparatus of claim 1, wherein the IF timing offset information reflector includes:
a jitter attenuator for attenuating jitter of sampling timing offset clock extracted in the timing recoverer; and
a digital-to-analog converter for performing digital-to-analog conversion by using the sampling timing offset clock whose jitter is attenuated in the jitter attenuator.

5. The apparatus of claim 1, wherein the IF timing offset information reflector includes:
a digital-to-analog converter for performing digital-to-analog conversion by using the sampling timing offset clock extracted from the timing recoverer.

6. The apparatus of claim 1, wherein the RF timing offset information reflector includes:
a reference frequency generator for generating reference frequency for an RF up-converter based on the sampling timing offset clock extracted in the timing recoverer.

7. A method for synchronizing frequency in distributed repeaters, comprising the steps of:
recovering sampling frequency of reception signals; and
reflecting recovered sampling frequency to IF transmission signals and RF transmission signals.
